(19) United States
(12) Patent Application Publication
(10) Pub. No.: US 2023/0297656 A1
(43) Pub. Date: Sep. 21, 2023

(54) Authorization method for authorizing an operation of a hand-held power tool as well as a hand-held power tool

(71) Applicant: Robert Bosch GmbH, Stuttgart (DE)

(72) Inventors: Cankal Altun, Stuttgart (DE); Joerg Hildebrandt, Lichtenwald (DE)

(21) Appl. No.: 18/174,329

(22) Filed: Feb. 24, 2023

(30) Foreign Application Priority Data
Mar. 18, 2022 (DE) 10 2022 202 683.7

(51) Int. Cl. G06F 21/32; G06F 21/35; B25F 5/00

(52) U.S. Cl. CPC G06F 21/32; G06F 21/35; B25F 5/00

(57) ABSTRACT

An authorization method for authorizing an operation of a hand-held power tool is proposed, with a verification step for verifying a user, in which an authentication of the user comprising at least one biometric data element is aligned with a database, wherein the verification step is performed continuously, in particular in a regular time interval, during the operation of the hand-held power tool, and at least the one biometric data element is captured in an authentication step during the operation of the hand-held power tool.

This application claims priority under 35 U.S.C. § 119 to patent application no. 10 2022 202 683.7, filed on Mar. 18, 2022 in Germany, the disclosure of which is incorporated herein by reference in its entirety.

### SUMMARY

An authorization method for authorizing an operation of a hand-held power tool is proposed, with a verification step for verifying a user, in which an authentication of the user comprising at least one biometric data element is aligned with a database, wherein the verification step is performed continuously, in particular in a regular time interval, during the operation of the hand-held power tool, and at least the one biometric data element is captured in an authentication step during the operation of the hand-held power tool.

Preferably, the authorization method is configured so as to enable operation of a hand-held power tool to be performed only by a clearly verified user. In particular, the authorization method is free of conventional authorization processes, such as entering a password/pin, entering a multi-factor authentication code, providing an RFID employee card, and/or performing a biometric verification using a fingerprint. A “biometric data element” is understood to mean a user's behavior, a user's working style, a user's handling of or interaction with a hand-held power tool or the like, and in particular not a fingerprint, handprint, iris, and/or facial information of a user or the like. An “authentication” is understood to mean a digital proof of identity of a user, by means of which a user is clearly identifiable. An “authorization” is intended to mean the granting of permission to a user to use a hand-held power tool after successful verification. When it is mentioned that the verification step is performed continuously during the operation of the hand-held power tool, it is to be understood that an authentication of a user of the hand-held power tool is continuously subjected to verification during the operation of the hand-held power tool. The time interval is at most preferably five minutes, preferably two minutes, more preferably one minute, and particularly preferably 30 seconds. Preferably, the at least one biometric data element is captured after turning on the hand-held power tool. Further biometric data elements are preferably captured after the time interval.

Preferably, the hand-held power tool comprises a battery as the power supply. The hand-held power tool is preferably configured as a drill-driver, an angular screwdriver, an angular grinder, a jig-saw or hand-held circular saw, a smartwatch, a smart wearable, or the like. It is conceivable that the authorization method will be used for authorizing an operation of other devices, such as computers, laptops, smartphones, or the like, that appear sensible to a person skilled in the art. Preferably, the hand-held power tool comprises a memory unit. The database is preferably stored on the memory unit. The database preferably comprises alignment data. The database, in particular the alignment data, is/are preferably used at least in the verification step in order to be aligned with the authentication of the user. The database, in particular the alignment data, comprise(s) at least alignment data from at least one user who is authorized to operate the hand-held power tool. Preferably, the database comprises alignment data from multiple users who are authorized to operate the hand-held power tool. In at least one method step, the database is preferably expanded with alignment data from further authorized users. In one method step, alignment data from authorized users is preferably removed from the database. Preferably, a user whose alignment data has been removed from the database is no longer authorized to operate the hand-held power tool. Preferably, in one method step, the alignment data is updated by an authorized user. Preferably, the hand-held power tool is turned off after the verification step when the verification of the authentication of the user is unsuccessful. When it is mentioned that the verification is unsuccessful, it should be understood that the authentication of the user, which comprises at least the one biometric data element, does not match the database, in particular the alignment data, and/or that no useful authentication that can be used for the verification has been captured. The hand-held power tool preferably comprises at least one HMI. The HMI is preferably configured as a display or touchscreen. Preferably, the result of the verification step is output to the user in an authorization step by means of the HMI. Preferably, the user is informed by means of the HMI, for example during the authorization step, whether or not the user is authorized to operate the hand-held power tool. In the authorization step, the hand-held power tool is released for operation by the user.

With the configuration of the method according to the disclosure, the operation of a hand-held power tool can be authorized without a password, an employee ID card, or the like. Advantageously, a security gap caused by the loss/disclosure and/or theft of a password/employee ID card or the like can be closed. Advantageously, a need for interaction with an HMI of the hand-held power tool for verification of a user can be reduced or completely ruled out. Advantageously, the identity of the user of the hand-held power tool can be continuously verified. Advantageously, a database of authorized users can be conveniently and easily updated.

Furthermore, it is proposed that, in the authentication step, the at least one captured biometric data element is configured at least as user-preferred tool settings, working styles, application-oriented processes, tool movements, tool and/or HMI interactions.

Preferably, the biometric data element is configured as a behavioral biometric data element. Preferably, the preferred tool settings consist of at least an on/off switching of specific tool settings, a preferred operating mode of the hand-held power tool, and/or a habit of using the hand-held power tool. The working style preferably consists of at least a division into aggressive or preventive working styles, the working style in a preparation cycle, a power cycle, and/or a load cycle, a battery usage behavior, a handling behavior with the hand-held power tool, in particular an orientation of the hand-held power tool during the operation, a reaction behavior to certain events, and/or a procedure for changing tools of the hand-held power tool. The application-oriented working style, at least when hammering, preferably consists of a strength of the vibration when pushing the hand-held power tool against a surface and/or an applied force on the housing/tool of the hand-held power tool. Preferably, the application-oriented working style for chiseling consists of at least an on/off sequence of operation of the hand-held power tool. Preferably, the application-oriented working style when grinding consists of at least a pressure on the grinding tool. The tool movement consists of at least a user's gait, a manner of climbing stairs, and/or a manner in which the user picks up and sets down the hand-held power tool. The tool interaction preferably consists of at least a size of at least one of the user's hands gripping the hand-held power tool, a temperature/humidity of the user's at least one gripping hand, a position of the user's at least one gripping hand, and/or the use of an additional gripping apparatus for gripping the hand-held power tool. The HMI interaction preferably consists of at least one manner, in particular related to pressure, speed, and/or aggressiveness, in which an on/off switch of the hand-held power tool is actuated. The HMI interaction preferably consists of at least how a button of the hand-held power tool is actuated, in particular at what speed, pressure, and/or frequency. The HMI interaction preferably consists of at least how a rotary knob of the hand-held power tool is actuated, in particular an operating mode relating to a pressure and/or a speed when switching the rotary knob. The HMI interaction preferably consists of at least how a shift actuator and/or an e-coupling of the hand-held power tool is controlled. Preferably, the database comprises alignment data for each biometric data element, which can uniquely identify an authorized user. Preferably, for filling the database, at least a portion of the alignment data is captured from a smartphone, a laptop, a computer, a smartwatch, and/or a smart wearable of the user of the hand-held power tool. In the authentication step, at least a portion of the authentication of the user, in particular at least a portion of the biometric data elements, is captured by the hand-held power tool. Preferably, at least a portion of the biometric data elements is captured by a temperature sensor, an accelerometer, a speed sensor, a pressure sensor, an orientation sensor, a battery management system, an ammeter, a voltmeter, or the like of the hand-held power tool. The configuration of the method can advantageously precisely and clearly determine the identity of an authorized user.

Further, it is proposed that, in a data collection step, the database is expanded with data from at least one portable device, a smartphone, employee records, and/or social media accounts. Preferably, the database is expanded with the data from the data collection step in addition to the alignment data of the database. Preferably, the data contains at least a current body temperature of the user of the hand-held power tool. Preferably, the user's body temperature is captured in the data collection step by means of a portable device, for example the smartwatch and/or the smart wearable, of the user. Preferably, in the data collection step, the database is expanded with data relating to gait of the user, for example when climbing stairs, by means of the portable device and/or the user's smartphone. Preferably, in the data collection step, the database is expanded with data relating to the working time and/or vacation time of the authorized user by means of the employee records. In the data collection step, data relating to the current locations of the user is preferably collected by means of the social media account of the user and transferred to the database. Preferably, in the verification step, the at least one authentication of the user with the database is aligned with the expanded data. Preferably, during the authentication step, the hand-held power tool captures the at least one authentication of the user that is configured so as to be aligned to the expanded data of the database. With the configuration of the method, the database can advantageously be expanded with further data for the unique identification of an authorized user. Further biometric data elements can advantageously be used as the authentication of the user.

Furthermore, it is proposed that, in the data collection step, the database is expanded with location data of the user, wherein the location data of the user is captured by various devices of the user that are different from the hand-held power tool, in particular smartwatches and/or smartphones. Preferably, in the authentication step, a current authentication of the user configured as location data is captured. Preferably, in the authentication step, the current location data of the user of the hand-held power tool is captured. The location data of the hand-held power tool is in particular captured by a GPS method. It is conceivable that the location data can be captured in the authentication step by means of various methods that appear to be sensible to a person skilled in the art, for example a location could be determined by evaluating the Wi-Fi signal of the hand-held power tool. Preferably, in the verification step, the authentication of the user with the database configured as the location of the hand-held power tool is aligned with the expanded location data. Preferably, in the data collection step, the location data of the user is transmitted from the devices that are different from the hand-held power tool over the internet. Preferably, in the verification step, it is verified whether the user's devices that are different from the hand-held power tool, in particular the smartphones and/or smartwatches, are in a common location with the hand-held power tool. When it is mentioned that the hand-held power tool and the devices that are different from the hand-held power tool are in a common location, it should be understood that they are located together in a delimited area, for example, a company premises, a workshop, a warehouse, or a similar working location. With the configuration of the method, a database can advantageously be further expanded. Further verification criteria for authorizing a user can advantageously be provided.

Further, it is proposed that the verification step, in particular the alignment of the at least one biometric data element with the database, is performed by a computing unit of the hand-held power tool. Preferably, the verification step, in particular the alignment of the database with the expanded data and the expanded location data, is performed by the computing unit of the hand-held power tool. Preferably, the computing unit accesses the database during the verification step. Preferably, the at least one captured authentication is sent to the computing unit. In particular, in the data collection step, the at least one captured authentication of the user is directed from the sensor unit to the computing unit. With the configuration of the method, the authorization of the user can advantageously be carried out directly on the hand-held power tool. Advantageously, a time-consuming data exchange between the hand-held power tool and a server and or a device that is different from the hand-held power tool can be omitted.

Furthermore, it is proposed that the verification step, in particular the alignment of the at least one biometric data element with the database, is performed by a server unit, in particular a gateway, a local server, and/or a cloud server, which communicates in particular wirelessly with the hand-held power tool. Preferably, the verification step, in particular the alignment of the database with the expanded data and the expanded location data, is performed by the server unit, in particular the gateway, the local server, and/or the cloud server. In particular, the server unit, in particular the gateway, the local server, and/or the cloud server comprise(s) a computing unit for performing the verification step. It is conceivable that the database is arranged on a memory unit not arranged in the hand-held power tool. In particular, the computing unit and the memory unit are in a common location. In particular, the memory unit comprising the database is part of the server unit, the local server, or the cloud server. However, it is also conceivable that the computing unit and the memory unit, in particular the database, are arranged at different locations. The wireless communication between the memory unit, which in particular comprises the database, and the computing unit preferably takes place via an internet connection. Preferably, during the verification step, the server unit, the local server, and/or the cloud server transmit a signal to the hand-held power tool with the result of the verification of the authentication of the user. Preferably, the hand-held power tool comprises a communication unit for communicating with the server unit, the local server, and/or the cloud server. With the configuration of the method, the authorization procedure can be provided for a hand-held power tool with low computing power. The method can be provided for a hand-held power tool having no computing units.

It is further proposed that, in a learning step, user-typical biometric data elements, which can be influenced in particular by a working environment, a task, and/or a working time, are stored in the database. In this context, “user-typical biometric data elements” should in particular be understood as habits, behaviors, and reactions of the user. In particular, the captured user-typical biometric data elements are stored in the learning step. Preferably, the user-typical biometric data elements are stored with additional information. The additional information preferably consists of at least one point in time, in particular a time of the day, week, month, and/or year of the capturing, work task of the user at the time of capturing, and/or special event at the time of or briefly prior to the capturing. Preferably, the user-typical biometric data elements are stored on the memory unit, in particular on a flash drive. The flash drive has a storage capacity of at least 250, preferably at least 500, and particularly preferably at least 750 last captured user typical biometric data elements. With the configuration of the method, habits, behaviors, and reactions of a user can be advantageously attributed to an event/time of a day/task. Reactions to upcoming events can be advantageously expected. Deviations from regular habits, behaviors, and reactions can be assessed advantageously intelligently and attributed to a user.

Furthermore, a hand-held power tool is proposed having at least one authorization apparatus, with at least one computing unit for performing the authorization method according to the disclosure. The authorization apparatus is preferably configured such that the user is authorized to operate the hand-held power tool upon successful verification. The authorization apparatus is in particular arranged in a housing of the hand-held power tool. Preferably, the authorization apparatus comprises at least the memory unit. Preferably, the database is stored on the memory unit. The database preferably contains at least the alignment data, the expanded data, and/or the location data. The database is preferably provided so as to be aligned with the at least one authentication of the user. The hand-held power tool preferably comprises at least the HMI. Preferably, the HMI is provided at least so as to indicate to the user the result of the verification. Preferably, the hand-held power tool comprises the on/off switch. The hand-held power tool is preferably configured such that the user can switch between different operating modes. The authorization apparatus preferably comprises a sensor unit. Preferably, the sensor unit comprises at least one, in particular a plurality of sensors. The sensor unit preferably comprises at least the temperature sensor, the accelerometer, the speed sensor, the pressure sensor, the orientation sensor, the ammeter, and/or the voltmeter. The sensor unit preferably comprises a locating element, which is provided for sensing a current location of the hand-held power tool. Preferably, the sensor unit is provided so as to make the at least one captured authentication of the user available to the computing unit. With the configuration of the hand-held power tool, the operation of the hand-held power tool can be authorized without a password, an employee ID card, or the like. Advantageously, a security gap caused by the loss/disclosure and/or theft of a password/employee ID card or the like can be closed. Advantageously, a need for interaction with an HMI of the hand-held power tool for verification of a user can be reduced or completely ruled out. Advantageously, the identity of the user of the hand-held power tool can be continuously verified.

Further, it is proposed that the computing unit is configured so as to align at least one biometric data element of a user with a database stored on the hand-held power tool, in particular to authorize the user to operate the hand-held power tool by way of the at least one biometric data element. The computing unit preferably comprises at least one microprocessor for alignment of the at least one biometric data element with the database. With the configuration of the hand-held power tool, the authorization of the user can advantageously be carried out directly on the hand-held power tool. Advantageously, a time-consuming data exchange between the hand-held power tool and a server and or a device that is different from the hand-held power tool can be omitted.

Furthermore, it is proposed that the authorization apparatus comprises at least one communication unit configured so as to communicate, in particular wirelessly, with a server unit, in particular a gateway, a local server, and/or a cloud server. Preferably, the communication unit is provided for a data exchange with the portable devices and/or the smartphone of the user. The communication unit preferably receives the alignment data, the data expanding the database, and the location data. The communication unit is preferably provided so as to transmit the received data to the computing unit. Preferably, the server unit, the local server, and/or the cloud server are provided so as to perform the alignment of the at least one biometric data element with the database, in particular in a configuration of the hand-held power tool without a computing unit. The server unit, the local server, and/or the cloud server preferably comprise(s) a computing unit for performing the alignment. The communication unit is in particular provided so as to receive the result of the alignment of the server unit, the local server, and/or the cloud server. With the configuration of the hand-held power tool, the authorization procedure can be provided for a hand-held power tool with low computing power. The authorization method can be provided for a hand-held power tool having no computing units.

The authorization method according to the disclosure for authorizing an operation of a hand-held power tool and/or the hand-held power tool according to the disclosure is/are not intended to be limited to the application and embodiment described above. In order to fulfill a functionality described herein, the authorization method according to the disclosure for authorizing an operation of a hand-held power tool and/or the hand-held power tool according to the disclosure can comprise in particular a number of individual elements, components, units, and method steps that deviate from a number mentioned herein. Moreover, for the ranges of values indicated in this disclosure, values lying within the mentioned limits are also intended to be considered disclosed and usable as desired.

### BRIEF DESCRIPTION OF THE DRAWINGS

Further advantages will become apparent from the following description of the drawing. The drawing shows an embodiment example of the disclosure. The drawings, the description, and the disclosure contain numerous features in combination. The person skilled in the art will expediently also consider the features individually and combine them into meaningful further combinations.

The Figures Show:

FIG. 1 a hand-held power tool according to the disclosure in a schematic representation; and

FIG. 2 an authorization method according to the present disclosure for authorizing an operation of a hand-held power tool in a schematic representation.

### DETAILED DESCRIPTION

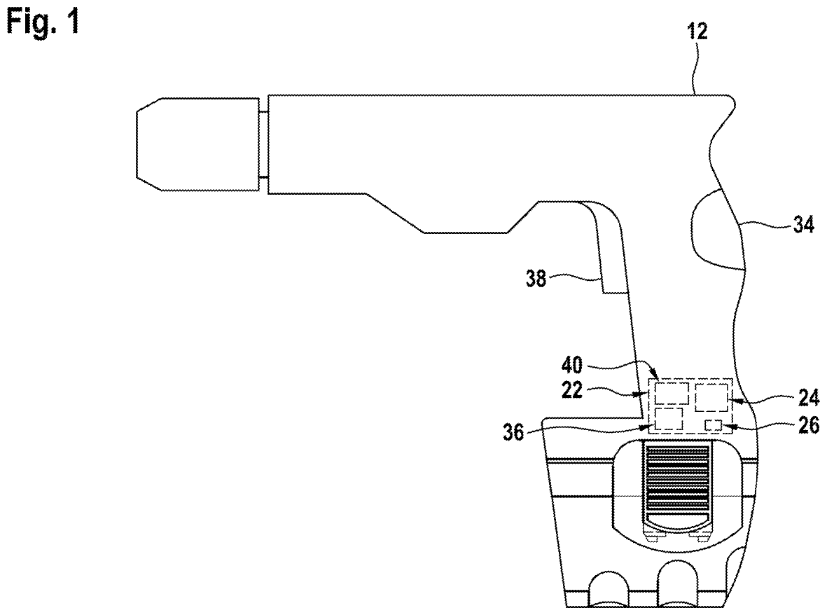

FIG. 1 shows a hand-held power tool 12 with an authorization apparatus 22. The authorization apparatus 22 comprises a computing unit 24 for performing an authorization method 10. The authorization apparatus 22 is configured such that the user is authorized to operate the hand-held power tool 12 upon successful verification. The authorization apparatus 22 is arranged in a housing of the hand-held power tool 12. The authorization apparatus 22 comprises a memory unit 36. A database 32 containing at least alignment data is stored on the memory unit 36. The database 32 is provided so as to be aligned with an authentication of a user. The hand-held power tool 12 comprises an HMI 34. The HMI 34 is configured as a touchscreen. The HMI 34 is provided so as to display a result of the authentication to the user. The hand-held power tool 12 comprises an on/off switch 38. The hand-held power tool 12 is configured such that the user can switch between different operating modes. The authorization apparatus 22 comprises a sensor unit 40. The sensor unit 40 comprises at least one, in particular a plurality of sensors. The sensor unit 40 comprises at least the temperature sensor, the accelerometer, the speed sensor, the pressure sensor, the orientation sensor, the ammeter, and/or the voltmeter. The sensor unit 40 comprises a locating element, which is provided for sensing a current location of the hand-held power tool 12. The sensor unit 40 is provided so as to make the at least one captured authentication of the user available to the computing unit 24. The hand-held power tool 12 comprises a battery for power supply. The computing unit 24 is configured so as to align at least one biometric data element 30 of a user with a database 32 stored on the hand-held power tool 12, in particular to authorize the user to operate the hand-held power tool 12 by way of the at least one biometric data element 30. The computing unit 24 comprises a microprocessor for alignment of the at least one biometric data element 30 with the database 32 (FIG. 1).

The authorization apparatus 22 comprises a communication unit 26 configured so as to communicate, in particular wirelessly, with a server unit, in particular a gateway, a local server, and/or a cloud server. The communication unit 26 is provided for a data exchange with the wearable devices and/or the smartphone of the user. The communication unit 26 receives the alignment data, the data expanding the database 32, and the location data. The communication unit 26 is provided so as to transmit the received data to the computing unit 24. The server unit, the local server, and/or the cloud server is/are provided so as to perform the alignment of the at least one biometric data element 30 with the database 32, in particular in a configuration of the hand-held power tool 12 without a computing unit 24. The server unit, the local server, and/or the cloud server comprise(s) a computing unit for performing the alignment. The communication unit 26 is provided so as to receive the result of the alignment of the server unit, the local server, and/or the cloud server (FIG. 1).

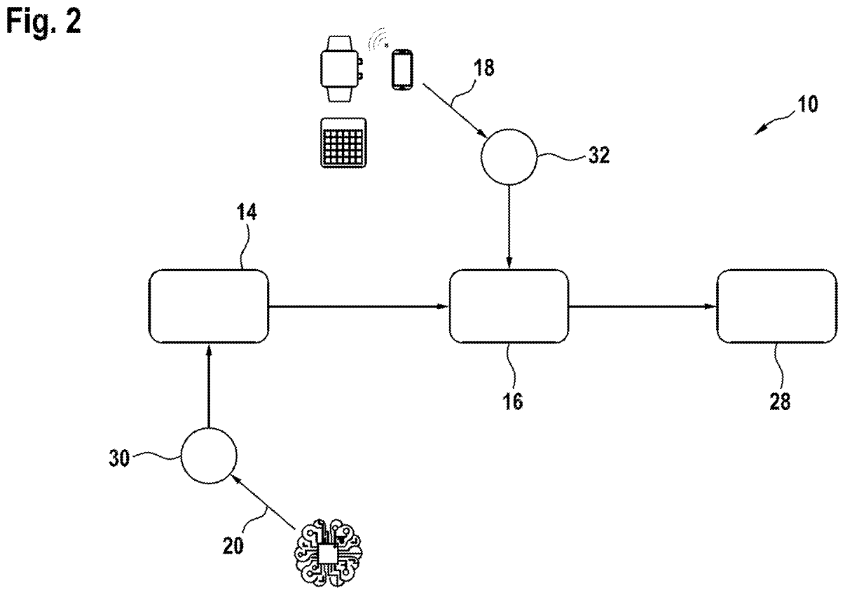

FIG. 2 shows the authorization method 10 for authorizing an operation of the hand-held power tool 12, with a verification step 16 for verifying a user, in which an authentication of the user comprising at least one biometric data element 30 is aligned with the database 32, wherein the verification step 16 is performed continuously, in particular in a regular time interval, during the operation of the hand-held power tool 12, and at least the one biometric data element 30 is captured in an authentication step 14 during the operation of the hand-held power tool 12. The authorization method 10 is configured so as to enable operation of a hand-held power tool 12 to be performed only by a clearly verified user. The time interval between two verification steps 16 is at most preferably five minutes, preferably two minutes, more preferably one minute, and particularly preferably 30 seconds. The at least one biometric data element 30 is captured after turning on the hand-held power tool 12. Further biometric data elements 30 are preferably captured at least in the time interval.

In one method step, the database 32 is expanded with alignment data from further authorized users. In one method step, the alignment data from authorized users is removed from the database 32. A user whose alignment data has been removed from the database 32 is no longer authorized to operate the hand-held power tool 12. In one method step, the alignment data is updated by an authorized user. The hand-held power tool 12 is turned off after the verification step 16 when the verification of the authentication of the user has been unsuccessful. The result of the verification step 16 is output to the user in an authorization step 28 by means of the HMI 34. The user is informed by means of the HMI 34, in particular during the authorization step 28, whether or not the user is authorized to operate the hand-held power tool 12 (FIG. 2).

In the authentication step 14, the at least one captured biometric data element 30 is configured at least as user-preferred tool settings, working styles, application-oriented processes, tool movements, tool and/or HMI interactions. The biometric data element 30 is configured as a behavioral biometric data element. The preferred tool settings consist of an on/off switching of specific tool settings, a preferred operating mode of the hand-held power tool 12, and/or a habit of using the hand-held power tool 12. The working style consists of a division into aggressive or preventive working styles, the working style in a preparation cycle, a power cycle, and/or a load cycle, a battery usage behavior, a handling behavior with the hand-held power tool 12, in particular an orientation of the hand-held power tool 12 during the operation, a reaction behavior to certain events, and/or a procedure for changing tools of the hand-held power tool 12. The application-oriented working style when hammering consists of a strength of the vibration when pushing the hand-held power tool 12 against a surface and/or an applied force on the housing/tool of the hand-held power tool 12. The application-oriented working style for chiseling consists of at least an on/off sequence of operation of the hand-held power tool 12. The application-oriented working style when grinding consists of at least a pressure on the grinding tool. The tool movement consists of a user's gait, a manner of climbing stairs, and/or a manner in which the user picks up and sets down the hand-held power tool 12. The tool interaction consists of at least a size of at least one of the user's hands gripping the hand-held power tool 12, a temperature/humidity of the user's at least one gripping hand, a position of the user's at least one gripping hand, and/or the use of an additional gripping apparatus for gripping the hand-held power tool 12. The HMI interaction consists of at least one manner, in particular related to pressure, speed, and/or aggressiveness, in which an on/off switch 38 of the hand-held power tool 12 is actuated. The HMI interaction consists of at least how a button of the hand-held power tool 12 is actuated, in particular at what speed, pressure, and/or frequency. The HMI interaction consists of at least how a rotary knob of the hand-held power tool 12 is actuated, in particular an operating mode relating to a pressure and/or a speed when switching the rotary knob. The HMI interaction consists of at least how a shift actuator and/or an e-coupling of the hand-held power tool 12 is controlled. The database 32 comprises alignment data for each biometric data element 30, which can uniquely identify an authorized user. For filling the database 32, a portion of the alignment data is captured from a smartphone, a laptop, a computer, a smartwatch, and/or a smart wearable of the user of the hand-held power tool 12. In the authentication step 14, at least a portion of the authentication of the user, in particular a portion of the biometric data elements 30, is captured by the hand-held power tool 12. A portion of the biometric data elements 30 is captured by a temperature sensor, an accelerometer, a speed sensor, a pressure sensor, an orientation sensor, a battery management system, an ammeter, a voltmeter, or the like of the hand-held power tool 12 (FIG. 2).

In a data collection step 18, the database 32 is expanded with data from at least one portable device, a smartphone, employee records, and/or social media accounts. The database 32 is expanded with the data from the data collection step 18 in addition to the alignment data of the database 32. The data contains a current body temperature of the user of the hand-held power tool 12. The user's body temperature is captured in the data collection step 18 by means of a portable device, in particular the smartwatch and/or the smart wearable, of the user. In the data collection step 18, the database 32 is expanded with data relating to gait of the user, in particular when climbing stairs, by means of the portable device and/or the user's smartphone. In the data collection step 18, the database 32 is expanded with data relating to the working time and/or vacation time of the authorized user by means of the employee records. In the data collection step 18, data relating to the current locations of the user is collected by means of the social media account of the user and transferred to the database 32. In the verification step 16, the at least one authentication of the user with the database 32 is aligned with the expanded data. During the authentication step 14, the hand-held power tool 12 captures the at least one authentication of the user that is configured so as to be aligned with the database 32, which has in particular been expanded with the data (FIG. 2).

In the data collection step 18, the database 32 is expanded with location data of the user, wherein the location data of the user is captured by various devices of the user that are different from the hand-held power tool 12, in particular smartwatches and/or smartphones. In the authentication step 14, a current authentication of the user configured as location data is captured. In the authentication step 14, the current location data of the user of the hand-held power tool 12 is captured. The location data of the hand-held power tool 12 is captured by a GPS method. In the verification step 16, the authentication of the user with the database 32 configured as the location of the hand-held power tool 12 is aligned with the expanded location data. In the data collection step 18, the location data of the user is transmitted to the hand-held power tool 12 from the devices that are different from the hand-held power tool 12 over the internet. In the verification step 16, it is verified whether the user's devices that are different from the hand-held power tool 12, in particular the smartphones and/or smartwatches, are in a common location with the hand-held power tool 12 (FIG. 2).

In a learning step 20, user-typical biometric data elements 30, which can be influenced in particular by a working environment, a task, and/or a working time, are stored in the database 32. In the learning step 20, the captured user-typical biometric data elements are stored. The user-typical biometric data elements are stored with additional information. The additional information consists of a point in time, in particular a time of the day, week, month, and/or year of the capturing, work task of the user at the time of capturing, and/or a special event at the time of or briefly prior to the capturing. The user-typical biometric data elements are stored on the memory unit 36, in particular on a flash drive. The flash drive has a storage capacity of at least 250, preferably at least 500, and particularly preferably at least 750 last captured user typical biometric data elements (FIG. 2).

The verification step 16, in particular the alignment of the at least one biometric data element 30 with the database 32, is performed by the computing unit 24 of the hand-held power tool 12. The verification step 16, in particular the alignment of the authentication of the user with the database 32, the expanded data, and the location data, is performed by the computing unit 24 of the hand-held power tool 12. The computing unit 24 accesses the database 32 during the verification step 16 (FIG. 2).

The verification step 16, in particular the alignment of the at least one biometric data element 30 with the database 32, is performed by a server unit, in particular a gateway, a local server, and/or a cloud server, which communicates in particular wirelessly with the hand-held power tool 12. The verification step 16, in particular the alignment of the authentication of the user with the database 32, the expanded data, and the location data, is performed by the server unit, in particular the gateway, the local server, and/or the cloud server. The server unit, in particular the gateway, the local server, and/or the cloud server comprise(s) a computing unit for performing the verification step 16. It is conceivable that the database 32 is arranged on a memory unit not arranged in the hand-held power tool 12. The computing unit and the memory unit are arranged in a common location. In particular, the memory unit comprising the database 32 is part of the server unit, the local server, or the cloud server. However, it is also conceivable that the computing unit and the memory unit, in particular the database 32, are arranged at different locations. The wireless communication between the memory unit, which in particular comprises the database 32, and the computing unit preferably takes place via an internet connection. During the verification step 16, the server unit, the local server, and/or the cloud server transmit(s) the result of the verification step 16 to the hand-held power tool 12. In the authorization step 28, operation of the hand-held power tool 12 is released to the authorized user (FIG. 2).

FIG. 2 further shows that the verification step 16 is performed chronologically after the authentication step 14. It is conceivable that the database 32, which is used in verification step 16 to align the authentication of the user, is updated prior to each verification step 16. However, the updating of the database 32 can also be omitted in individual authentication steps 16. The authorization step 28 is performed chronologically after the verification step 16.

What is claimed is:

1. An authorization method for authorizing an operation of a hand-held power tool, comprising:
verifying a user, wherein:
verifying the user includes aligning an authentication of the user, the authentication of the user comprising at least one biometric data element, with a database,
verifying the user is performed continuously, in particular in a regular time interval, during the operation of the hand-held power tool, and
the at least one biometric data element is captured in an authentication step during the operation of the hand-held power tool.

2. The authorization method according to claim 1, wherein:
in the authentication step the at least one captured biometric data element is configured at least as one of a user-preferred tool setting, a working style, an application-oriented process, a tool movement, a tool, and an HMI interaction.

3. The authorization method according to claim 1, further comprising:
expanding the database with data from at least one of a portable device, a smartphone, employee records, and a social media account.

4. The authorization method according to claim 3, wherein:
the database is expanded with location data of the user; and
the location data of the user is captured by at least one device of the user that is different from the hand-held power tool, in particular a smartwatch and/or a smartphone.

5. The authorization method according to claim 1, wherein the alignment of the at least one biometric data element with the database is performed by a computing unit of the hand-held power tool.

6. The authorization method according to claim 1, wherein the alignment of the at least one biometric data element with the database is performed by a server unit, in particular one of a gateway, a local server, and a cloud server, which communicates in particular wirelessly with the hand-held power tool.

7. The authorization method according to claim 1, further comprising:
storing user-typical biometric data elements, which can be influenced in particular by a working environment, a task, and/or a working time, in the database.

8. A hand-held power tool having at least one authorization apparatus with at least one computing unit configured to perform the authorization method according to claim 1.

9. The hand-held power tool according to claim 8, wherein:
the computing unit is configured to align the at least one biometric data element of the user with the database to authorize the user to operate the hand-held power tool by way of the at least one biometric data element; and
the database is stored on the hand-held power tool.

10. The hand-held power tool according to claim 8, wherein the at least one authorization apparatus comprises at least one communication unit configured to communicate, in particular wirelessly, with at least one server unit, in particular a gateway, a local server, and/or a cloud server.
